(19) United States
(12) Patent Application Publication
(10) Pub. No.: US 2006/0288619 A1
(43) Pub. Date: Dec. 28, 2006

(54) Point of purchase display

(75) Inventors: David R. Henke, Maple Grove, MN (US); Jeffrey T. Given, St. Paul, MN (US)

Correspondence Address: HAMRE, SCHUMANN, MUELLER & LARSON, P.C., P.O. BOX 2902, MINNEAPOLIS, MN, 55402-0902, US

(73) Assignee: Warner Manufacturing Company, Minneapolis, MN (US)

(21) Appl. No.: 11/142,027

(22) Filed: Jun. 1, 2005

(51) Int. Cl. G09F 15/00

(52) U.S. Cl. 40/606.08

(57) ABSTRACT

A point of purchase display for displaying and selling products, where the display facilitates user selection of the appropriate product for purchase from a group of products. The point of purchase display is particularly beneficial for use with hand tools, for example paint and decorating hand tools and related accessories. In the case of paint and decorating hand tools, the display is designed to assist the user in selecting the appropriate tool that is needed by the purchaser for the task that needs to be performed. The point of purchase display uses color, text, and/or illustrations to assist the purchaser in selecting the appropriate product for purchase.

### FIELD

The disclosed technology relates to a point of purchase display for displaying and selling products. More particularly, the disclosed technology relates to a point of purchase display for displaying and selling, for example, hand tools such as paint and decorating hand tools, that facilitates user selection of the appropriate tool for purchase from a group of tools.

### BACKGROUND

There is a vast array of products available for sale in the marketplace. Often times, in a retail environment, the products are displayed adjacent similar products or related products. As a result, when seeking to purchase a particular product, the consumer can be faced with a large number of products to choose from, and it can be difficult to select the appropriate product.

One example of such a product is hand tools. Hand tools are often designed primarily for use in a particular area of use, and each tool is generally designed to perform a specific type of job within the area of use. For example, some hand tools are designed primarily for use in paint and decorating projects. In addition, paint and decorating hand tools can be further divided into the type of paint and decorating job that the tool is primarily designed to perform, for example scraping tools for use in scraping surfaces, spreading tools that are designed for spreading various materials on surfaces, cutting tools for use in cutting various materials, and others.

A problem with many hand tools, including paint and decorating tools, is that many of the tools may look similar to one another, even though they may be constructed differently to perform quite different functions. For example, in one type of paint and decorating tool, often termed a putty knife, the putty knife can be designed primarily for scraping, or the putty knife can be designed primarily for spreading various materials. The flexibility of the knife portion of the putty knife typically varies depending upon the function that the putty knife is to perform (i.e. scraping or spreading) although each putty knife often looks generally similar in overall appearance. U.S. Pat. No. 6,668,751 discloses an approach to facilitate user selection of a tool, for example a putty knife.

In addition, many groups of tools include specialized tools that are designed to perform specific functions. To someone in need of a specialized tool for a specific task, but who is unfamiliar with these specialized tools and what they are to be used for, that person may not have sufficient knowledge to select and purchase the appropriate tool.

As a result, when purchasing a hand tool(s), proper selection of the appropriate tool for the task at hand can be difficult unless the purchaser has experience with the tool and knows what to look for. If the purchaser lacks familiarity with tools and the differences between various tools, the incorrect tool may be purchased for the required task. This problem is increasing as a result of the increasing number of homeowners and other do-it-yourselfers who are purchasing hand tools for home repair and home maintenance projects, who may have minimal or no prior experience with such tools. Even if the correct tool is purchased, it may have taken the purchaser a significant amount of time to determine which is the appropriate tool to purchase.

Thus, there is a need for a system that facilitates user selection and purchase of products such as paint and decorating hand tools to make it more likely that the user selects the correct tool needed for the task the purchaser needs to perform.

### SUMMARY

This disclosure relates to a point of purchase display for displaying and selling products, where the display facilitates user selection of the appropriate product for purchase from a group of products. The point of purchase display is particularly beneficial for use with hand tools, for example paint and decorating hand tools and related accessories. In the case of paint and decorating hand tools, the display is designed to assist the user in selecting the appropriate tool that is needed by the purchaser for the task that needs to be performed.

The point of purchase display uses color and/or text and/or illustrations to assist the purchaser in selecting the appropriate product for purchase. The use of color helps to, for example, categorize the products and draw the purchaser's attention to a particular product category. The use of text helps to, for example, explain the product category and its contents, as well as explaining the products e.g. what each product is and what each product does. The use of illustrations assists in, for example, explaining the intended use of the products in a category and drawing the purchaser's attention to particular products.

In addition, the product packaging can also include color and/or text and/or illustrations. The packaging can comprise labels affixed to the products, packages to which the products are secured, and/or containers in which the products are disposed. The color, text, and illustrations can be incorporated on the labels, the packages, or on the containers.

The point of purchase display includes at least one display section, and preferably at least two display sections. Each display section can include one or more of the following components: a header, a product mount area where product is mounted for display, and containers that contain products suitable for that display section. In one implementation, the header is disposed at the top of the display section, the product mount area is beneath the header, and the containers are beneath the product mount area.

Further, the products within each display section can be divided based on a variety of criteria, for example product quality and/or price. As an example, the product can be divided so that higher quality/priced products are located higher up in the display section, for example in the product mount area, middle quality/priced products are located in the middle, for example lower in the product mount area or higher in the containers, and lower quality/priced products are located lower in the display section, for example in the lowest containers.

### DESCRIPTION OF THE DRAWINGS

The patent or application file contains at least one drawing or photograph executed in color. Copies of this patent or patent application publication with color drawing(s) will be provided by the United States Patent and Trademark Office upon request and payment of the necessary fee.

FIG. 1 is a diagrammatic illustration of a point of purchase display according to the invention.

FIG. 2 is a color photograph of a specific exemplary implementation of a point of purchase display applied to paint and decorating tools in accordance with the invention.

FIG. 3 illustrates a header used in the point of purchase display of FIG. 2.

FIG. 4 illustrates a backdrop used in one of the tool mount areas of the display of FIG. 2.

FIG. 5 is an example of a container used in one of the display sections of the display of FIG. 2.

FIG. 6 is an example of a label for use on a container.

FIG. 7 illustrates a tool and its accompanying package according to the invention.

FIG. 8 illustrates another embodiment of a tool with an alternative form of packaging according to the invention.

### DETAILED DESCRIPTION

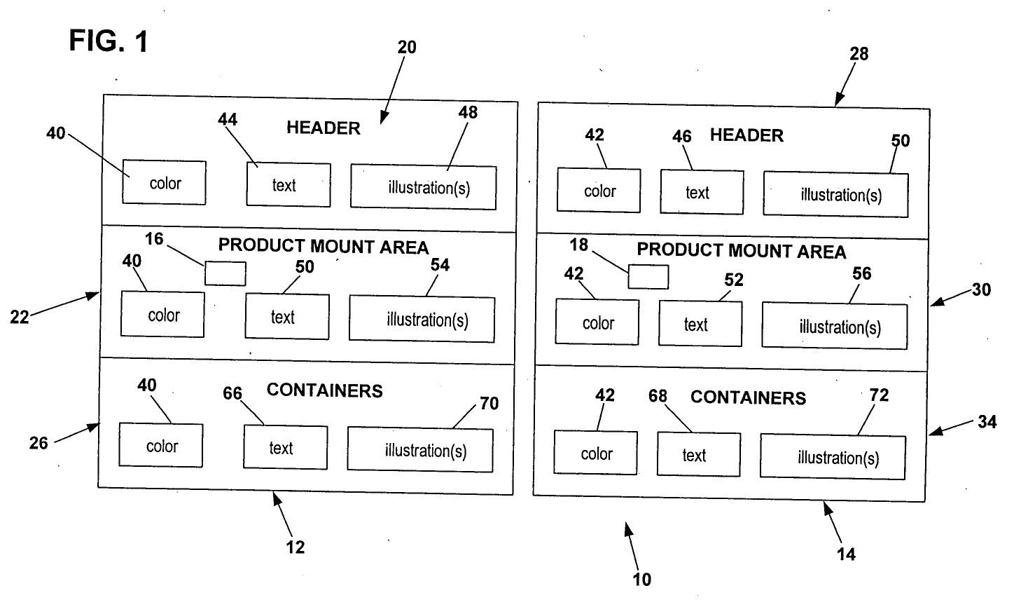

Referring initially to FIG. 1, a diagrammatic illustration of a point of purchase display 10 according to the invention is illustrated. The display 10 is designed to facilitate user selection of an appropriate product for purchase from a group of products.

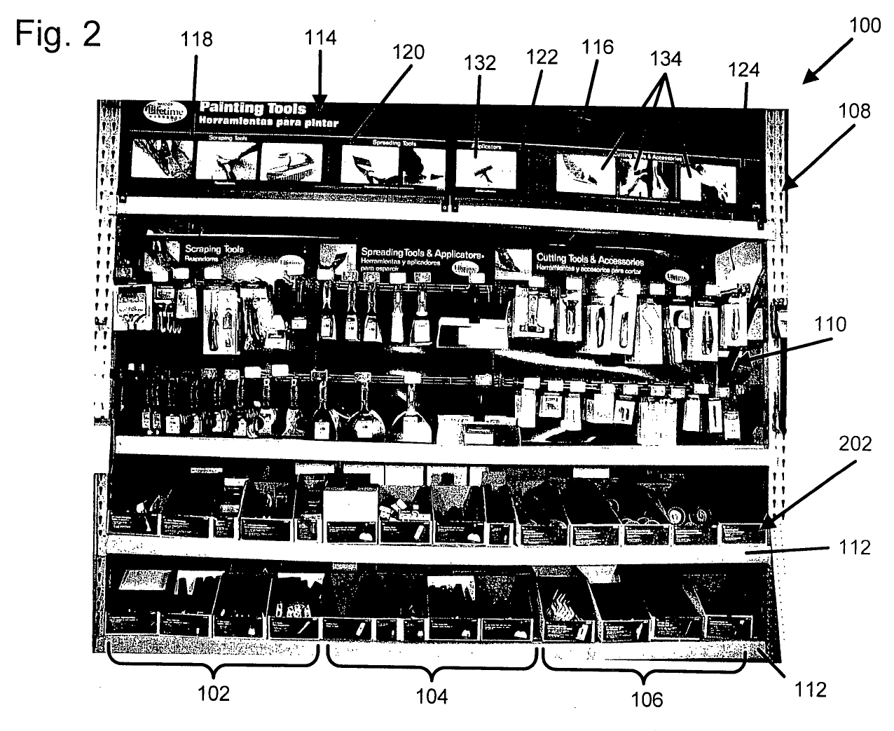

The point of purchase display 10 includes at least one display section 12, and preferably at least two display sections 12, 14. Each display section 12, 14 displays a particular category of product. For example, display section 12 can display a product(s) 16 primarily used for scraping surfaces while display section 14 can display a product(s) 18 primarily used for spreading materials onto a surface, as will be described below with respect to FIGS. 2-8.

The display section 12 depicted in FIG. 1 includes a header 20, a product mount area 22 where a plurality of products 16 are mounted for display, and containers 26 that contain additional products. The display section 12 is generally vertically arranged, whereby the header 20 is disposed at the top of the display section, the mount area 22 is beneath the header, and the containers 26 are beneath the product mount area.

Likewise, the display section 14 depicted in FIG. 1 includes a header 28, a product mount area 30 where a plurality of products 18 are mounted for display, and containers 34 that contain additional products. The display section 14 is generally vertically arranged, whereby the header 28 is disposed at the top of the display section, the mount area 30 is beneath the header, and the containers 34 are beneath the product mount area.

Each display section 12, 14 uses color, text, and/or illustrations to assist the purchaser in selecting the appropriate product(s) 16, 18 for purchase. The use of color helps to, for example, categorize the products and draw the purchaser's attention to a particular product category. The use of text helps to, for example, explain the product category and its contents, as well as explaining the products e.g. what each product is and what each product does. The use of illustrations assists in, for example, explaining the intended use of the products in a category and draws the purchaser's attention to particular products.

In addition, the product packaging can also include color, text, and/or illustrations. The packaging can comprise labels affixed to the products, packages to which the products are secured, and/or the containers 26, 34 in which the products are disposed. The color, text, and illustrations can be incorporated on the labels, the packages, or on the containers.

In particular, at least a portion of the header 20 of the display section 12 is provided with color 40, for example red, while at least a portion of the header 28 of the display section 14 is provided with color 42, different from the color 40, for example blue. In addition, the header 20 can include text 44 while the header 28 can include text 46, with the text 44, 46 explaining the product category within the display sections 12, 14 and its contents and/or explaining the products within the display section 12, 14. Further, the header 20 can include illustration(s) 48 while the header 28 can include illustration(s) 50 to assist in explaining the intended use of the products within the display sections 12, 14 and/or drawing the purchaser's attention to particular products.

The mount area 22 and containers 26 are also provided with color 40, corresponding to the color 40 used in the header 20. In addition, products 16 within the mount area 22 and/or in the containers 26 can also include the color 40. Since a similar color 40 is used in the sections 20, 22, 26, and on the products, a user knows that a product that bears that color 40 belongs to the display section 12 and is to be used for a task associated with the display section 12. In a similar manner, the mount area 30, the containers 34, products 18 within the mount area 30 and/or in the containers 34 can also include the color 42, thereby differentiating the products within the display section 14 from the products within the display section 12.

To further aid the user in selecting the appropriate product, the mount areas 22, 30 can also include text 50, 52 and/or illustration(s) 54, 56. The text 50, 52 can be the same as or different than the text 44, 46 used in the headers 20, 28. In addition, the illustration(s) 54, 56 can be the same as or different than the illustration(s) used in the headers 20, 28.

The containers 26, 34 also include text 66, 68 and/or illustration(s) 70, 72. The text 66, 68 and the illustration(s) 70, 72 on the containers 26, 34 are preferably specific to the product contained with the containers, and is generally different than the text and/or illustrations in the other sections.

The products 16, 18 in the mount areas 22, 30 and products in the containers 26, 34 can also include text and/or illustrations, for example on labels affixed to the products, packaging for the products, or on the products themselves.

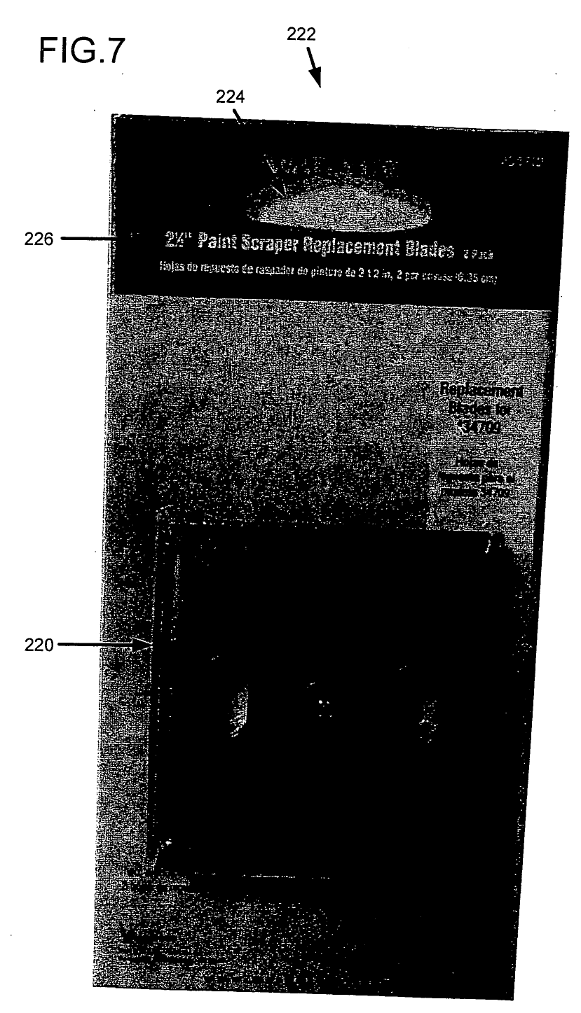

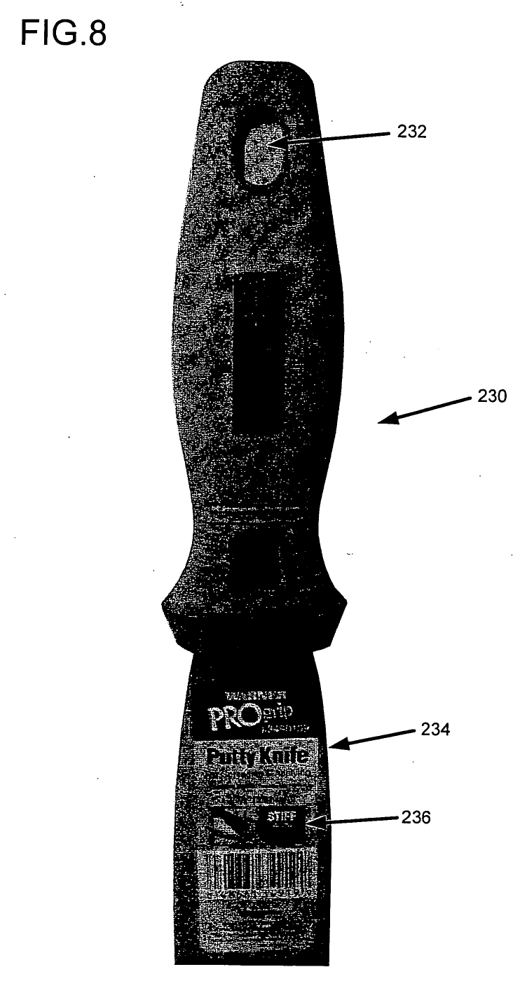

Turning now to FIGS. 2-8, a specific implementation of a point of purchase display 100 is shown. The display 100 is used for a variety of paint and decorating tools, for example scraping tools used for scraping surfaces, spreading and applicator tools for spreading and applying material onto surfaces, cutting tools for cutting, and accessories for painting and decorating. As used herein, the term “tool” and “tools” refers to not only the tools themselves, but also to replacement parts, such as replacement blades, for use with the tools. Examples of tools that can be used with the display 100 include the tools disclosed in U.S. Pat. No. 6,668,751, as well as the tools disclosed in FIGS. 7 and 8.

In FIG. 2, the display 100 includes display sections 102, 104, 106, with display section 102 being distinguished by a first color, for example red, the display section 104 distinguished by a second color, for example blue, and the display section 106 distinguished by a third color, for example green. The display 100 is shown used with support frame 108 of a type known in the art. The frame 108 includes a pegboard section 110, forming a product mount area, on which a plurality of hooks are mounted for displaying paint and decorating tools, and a plurality of shelves 112. The use and construction of pegboard and hooks for displaying products is known in the art. However, it is to be realized that the concepts of the display 100 can be used with other types of support frames and supports.

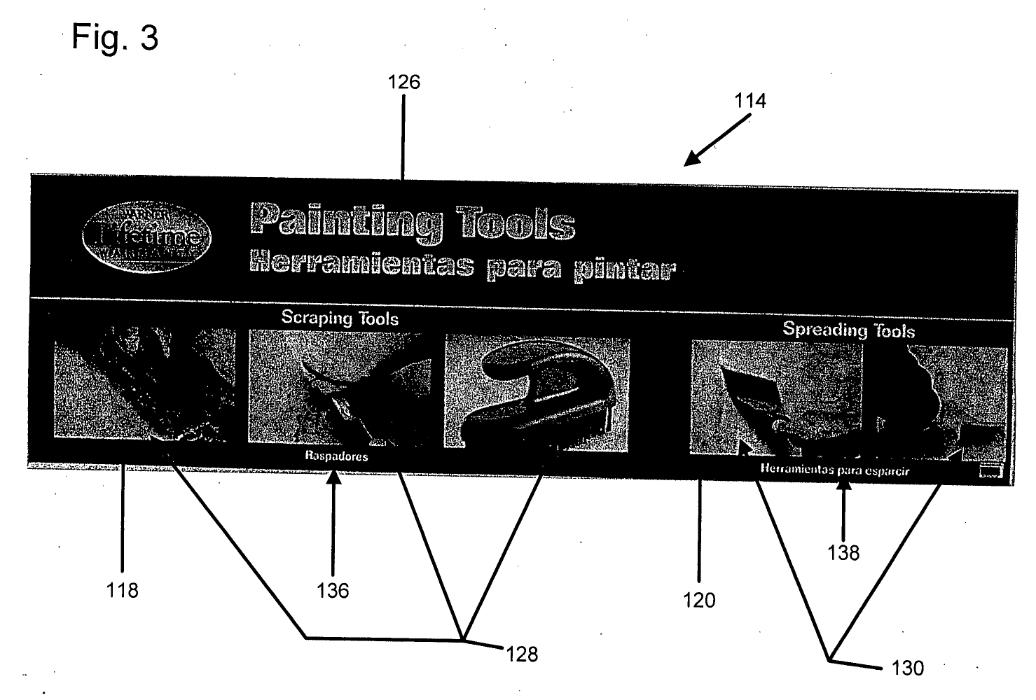

With reference to FIGS. 2 and 3, the display 100 includes a header 114 that is shared between the display sections 102, 104, and a header 116 that is shared between the display sections 104, 106. The header 114 includes a first colored section 118, for example a red color, that serves to distinguish the display section 102 from the display sections 104, 106, and a second colored section 120, for example a blue color, that serves to distinguish the display section 104 from the display sections 102, 106. Likewise, the header 116 includes a first colored section 122, for example a blue color, that continues from the header 114 in distinguishing the display section 104, and a second color section 124, for example a green color, that serves to distinguish the display section 106 from the display sections 102, 104.

Further, the header 114 includes text 126, for example “Painting Tools”, that explains the purpose, e.g. painting and decorating, of the tools within the display 100. The colored sections 118, 120, 122, 124 also include illustrations 128, 130, 132, 134 in the form of photographs that show examples of tools that can be included within each display section 102-106, as well as demonstrating exemplary uses for the tools in the display sections. Adjacent the illustrations 128-134 is additional text 136, 138 that explains the specific uses of the tools in each display section, e.g. tools for scraping, tools for spreading, applicator tools, cutting tools and accessories.

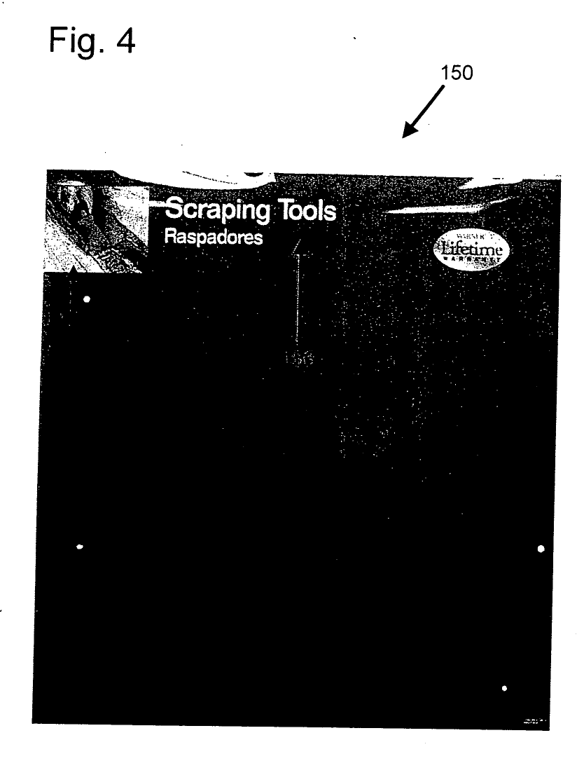

FIG. 4 illustrates an example backdrop 150 that is used in the pegboard section 110.

Each backdrop 150 is substantially solid in color, matching the colors used on the colored sections 118, 120, 122, 124. As shown in FIG. 2, the backdrops 150 form the background for the pegboard section 110, and the hooks for hanging tools in the pegboard section extend in front of the backdrops. The backdrops 150 further include text 156, with the text 156 being the same as the text 136. In addition, the backdrops 150 each include an illustration 162, which can be, for example, similar to one of the illustrations 128, 130, 132, 134 used in the colored sections 118-124, again providing an example of a tool that can be included within each display section 102-106 as well as demonstrating an exemplary use for the tools in the display sections.

As shown in FIG. 2, a plurality of containers 202 are disposed on the shelves 112. The containers 202 can contain extra supplies of the tools that are mounted on the pegboard section 110 and/or supplies of tools that are not mounted on the pegboard but which perform a function consistent with the display section in which the container is disposed.

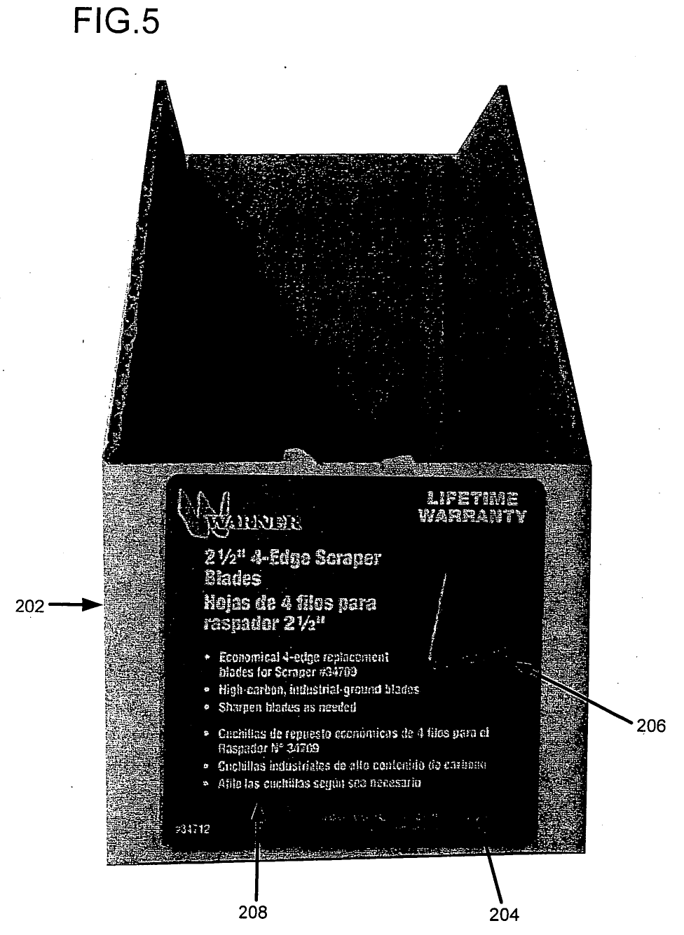

An example of a container 202 used in the display section 102 is illustrated in FIG. 5. The container 202 is shown as a cut carton structure formed out of corrugated cardboard. The carton has an interior volume sufficient to hold a plurality of tools, which are illustrated in FIG. 5 as being scraper blades for use in a scraper tool. A label 204 is affixed to the front surface of the container 202, which surface is the intended visible surface when the container is used in the display. The label 204 is colored to match the color used for the display section 102 so that the purchaser knows that tools within the container 202 perform a function consistent with the display section 102. The label 204 further includes an illustration 206 of the tool, e.g. scraper blades, that is contained in the container 202, as well as text 208 describing the tool in the container, including for example what it is, what is does or is used for, what it is made of, size, etc.

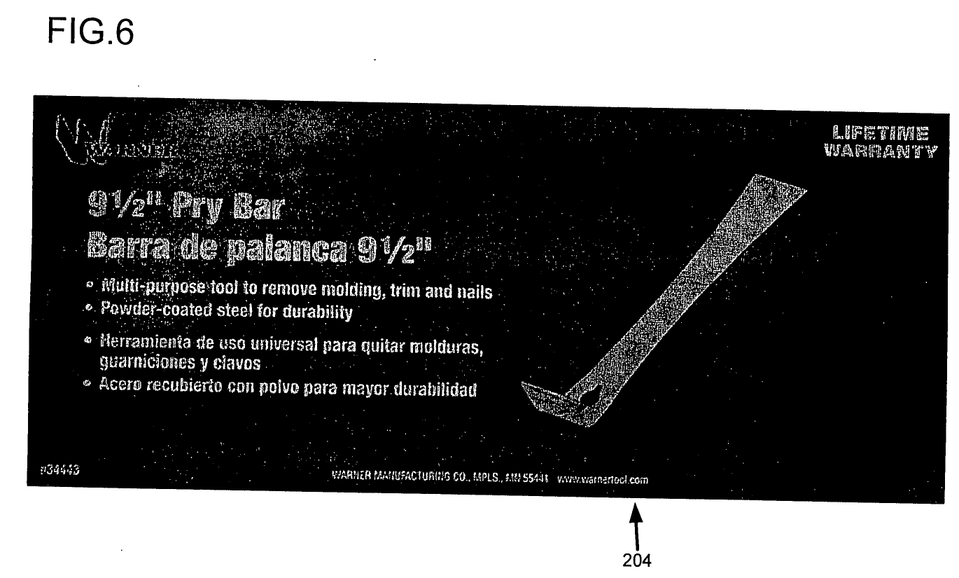

The labels 204 are preferably manufactured separately from the containers 202, as shown in FIG. 6, thereby allowing flexibility in tool display. If a container is to hold a tool that is different from what it held before, a new label for that tool can be affixed to the container 202, over any existing label. As a result, separate labels allow repeated use of the containers by replacing labels as needed.

The labels 204 are formed from, for example, a paper substrate with an adhesive backing for adhering the labels to the containers 202. The labels 204 could be vinyl instead of paper is desired. The adhesive backing is provided on a rear surface of the label so that the label can releasably adhere to a backing sheet. The front surface of the label is provided with a non-white and non-black background, for example red, blue or green.

FIG. 7 illustrates a tool 220, for example a scraper, that can be hung in the pegboard section 10 of the display 100. The tool 220 is provided with a package 222 affixed to the tool, with the package including a hole 224 for mounting the package 222 and tool 220 to a hook on the pegboard section 110 as shown in FIG. 2. A portion of the package 222, for example the upper portion, is colored the same color, for example red, as used in the other portions of the display section 102. By having the same color, the purchaser knows that the tool 220 belongs to the tools included within the tools of the display section 102. The package 222 also includes a description 226 of the tool.

FIG. 8 illustrates another example of a tool 230, for example a putty knife, that can be hung in the pegboard section 110 of the display 100, for example in the pegboard section of the display section 104. In this case, the handle of the tool 230 includes a hole 232 for mounting the tool 230 to a hook on the pegboard section 110 as shown in FIG. 2. The blade of the tool 230 includes a label 234 attached thereto. A portion of the label 234 is colored the same color, for example blue, as used in the other portions of the display section 104. By having the same color, the purchaser knows that the tool 230 belongs to the tools included within the tools of the display section 104.

The label 234 also includes a graphics box 236 including illustrations and text that serve to explain what the colors used in the display sections 102, 104 are meant to signify. For example, the box 236 contains an illustration of a colored device scraping a surface, the color of the device matching the color used in the display section 102, with words, for example “Stiff”, signifying that the scraping devices in the display section 102 bearing a similar color are relatively stiff. The label 234 also includes text to indicate, for example, the type of tool, what it does, its size, etc.

It is expected that higher quality tools will be mounted in the pegboard section 110, medium quality tools will be mounted lower in the pegboard 110 or higher up on the shelves 112 in the containers 202, and lower quality tools will occupy the lowermost containers 202. However, the arrangement of the tools could have other variations as well.

To further enhance separation of the display sections 102-106, colored dividers can be utilized to separate the display sections. The dividers would be colored to correspond to the particular display section it is associated with, and the dividers can be mounted on, for example, the pegboard sections, to extend vertically in the display.

As should be apparent, the point of purchase display 100 is designed to facilitate user selection of the appropriate tool. When approaching the display 100, the potential purchaser sees the text 126 indicating the purpose of the tools, and is put on notice by the differing colors that there may be a difference between the tools. The illustrations and text help to guide the purchaser to the proper tool, by illustrating to the user examples of how the tools in each display section are to be used, as well as explaining how the tools are used. Once the purchaser identifies the correct display section that encompasses the tools needed to accomplish the task at hand, the purchaser can then focus on the tools within the display section that bear a common color. The descriptions on the tools, together with any illustrations, can then guide the purchaser to a suitable tool.

Although the description refers to red, blue and green colors as the colors of the display sections 102-106, other colors can be used in place of red, blue and green. In addition, the colors need not be solid colors; combinations of colors could be used in the display sections 102-106, and color can implemented in a pattern, for example red, blue or green checkerboard patterns.

What is claimed is:

1. A point of purchase display for paint and decorating tools, comprising:
at least first and second display sections arranged generally side-by-side, the first display section having a first color assigned thereto and the second display section having a second color assigned thereto, where the first color and the second color are different colors, and the first and second colors identify the type of paint and decorating tool included within the first and second display sections, respectively;
the first display section including:
i) a first plurality of paint and decorating tools, the tools of the first plurality of tools including packaging containing the first color,
ii) a first header containing the first color, and the first header being positioned above the first plurality of tools, and
iii) a first backdrop below the first header, the majority of the first backdrop comprises the first color;
and the second display section including:
i) a second plurality of paint and decorating tools, the tools of the second plurality of tools including packaging containing the second color,
ii) a second header containing the second color, and the second header being positioned above the second plurality of tools, and
iii) a second backdrop below the second header, the majority of the second backdrop comprises the second color.

2. The display of claim 1, wherein the packaging comprises labels affixed to the first and second plurality of tools.

3. The display of claim 1, wherein the packaging comprises packages to which the first and second plurality of tools are secured, and the packages are configured to mount the tools of the first and second plurality of tools on the first and second backdrops, respectively.

4. The display of claim 1, wherein the packaging comprises containers in which the first and second plurality of tools are disposed.

5. The display of claim 4, wherein each container of the first display section has a label containing the first color, and each container of the second display section has a label containing the second color.

6. The display of claim 1, wherein the packaging of the first and second plurality of tools, the first and second headers, and the first and second backdrops each include text and/or an illustration, wherein the text and/or illustration identifies the type of paint and decorating tool included within the first and second display sections.

7. The display of claim 1, wherein the first plurality of tools includes scraping tools and the second plurality of tools includes spreading tools or cutting tools.

8. The display of claim 5, wherein the labels of the containers contain an illustration of the tools contained within the respective container.

9. The display of claim 8, wherein the labels of the containers contain text describing the tools contained within the respective container.

10. A point of purchase display, comprising:
a first display section having a first color assigned thereto, the first color identifying a type of product included within the first display section, the first display section including:
i) a first plurality of products, the products including packaging containing the first color,
ii) a first header bearing the first color, and the first header being positioned above the first plurality of products, and
iii) a first backdrop below the first header, the majority of the first backdrop comprises the first color.

11. The display of claim 10, further comprising:
a second display section arranged adjacent the first display section, the second display section having a second color assigned thereto, wherein the first color and the second color are different colors, and the second color identifies a type of product included within the second display section, and the second display section including:
i) a second plurality of products, the products including packaging containing the second color,
ii) a second header bearing the second color, and the second header being positioned above the second plurality of products and
iii) a second backdrop below the second header, the majority of the second backdrop comprises the second color.

12. The display of claim 11, wherein the packaging comprises labels affixed to the first and second plurality of products.

13. The display of claim 11, wherein the packaging comprises packages to which the first and second plurality of products are secured, and the packages are configured to mount the products of the first and second plurality of products on the first and second backdrops, respectively.

14. The display of claim 11, wherein the packaging comprises containers in which the first and second plurality of products are disposed.

15. The display of claim 14, wherein each container of the first display section has a label containing the first color, and each container of the second display section has a label containing the second color.

16. The display of claim 11, wherein the packaging of the first and second plurality of products, the first and second headers, and the first and second backdrops each include text and/or an illustration, and wherein the text and/or illustration identifies the type of product included within the first and second display sections.

17. The display of claim 15, wherein the labels of the containers contain an illustration of the product contained within the respective container.

18. The display of claim 17, wherein the labels of the containers contain text describing the product contained within the respective container.

19. A container for use in a point of purchase display, comprising:
a container structure having a surface that is intended to be a visible surface when the container is used in the point of purchase display; and
a label affixed to the visible surface, the label including:
i) a background that is a non-white and non-black color,
ii) an illustration of product contained within the container structure, and
iii) text describing the product contained within the container structure.

20. The container of claim 19, wherein the container structure is a cut carton.

21. The container of claim 19, wherein the illustration is an illustration of a paint and decorating tool.

22. The container of claim 19, wherein the non-white and non-black color comprises a color selected from red, blue or green.

23. A label for use on a container of a point of purchase display, comprising:
a substrate having a front surface with a background that is a non-white and non-black color;
an illustration of product that is intended to be contained within the container on which the label will be disposed provided on the front surface of the substrate; and
text on the front surface describing the product that is to be contained within the container on which the label will be disposed.

24. The label of claim 23, wherein the illustration is an illustration of a paint and decorating tool.

25. The label of claim 23, wherein the non-white and non-black color comprises a color selected from red, blue or green.
